(19) United States
(12) Patent Application Publication
(10) Pub. No.: US 2010/0039842 A1
(43) Pub. Date: Feb. 18, 2010

(54) POWER CONVERSION SYSTEM AND POWER CONVERSION METHOD THEREOF

(75) Inventors: Yi-Te LIU, Jhubei City (TW); Chih-Yuan Hsieh, Hsinchu City (TW); Chih-Jen Yen, Hsinchu City (TW); Lan-Shan Cheng, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/353,399

(22) Filed: Jan. 14, 2009

(30) Foreign Application Priority Data
Aug. 15, 2008 (TW) 97131340

(51) Int. Cl. H02M 7/06

(52) U.S. Cl. 363/126

(57) ABSTRACT

A power conversion system and a power conversion method thereof. The power conversion system includes a driving unit, a control unit, a first direct current (DC) power supply circuit and a second DC power supply circuit. The control unit controls the driving unit to drive a load. The first DC power supply circuit converts an alternating current (AC) power into a first DC power outputted to the driving unit, and the second DC power supply circuit converts the AC power into a second DC power outputted to the control unit.

This application claims the benefit of Taiwan application Serial No. 97131340, filed Aug. 15, 2008, the subject matter of which is incorporated herein by reference.

### BACKGROUND OF THE INVENTION

1. Field of the Invention

The invention relates in general to a power conversion system and a power conversion method thereof, and more particularly to a power conversion system for respectively and independently supplying electric powers to a driving unit and a control unit, and a power conversion method thereof.

2. Description of the Related Art

FIG. 1 (Prior Art) is a schematic illustration showing a conventional power conversion system 10 for driving a load. FIG. 2 (Prior Art) shows a waveform of a direct current (DC) power. Referring to FIGS. 1 and 2, the conventional power conversion system 10 includes a rectifying unit 110, a capacitor Cin1, a control unit 140 and a driving unit 130. The rectifying unit 110 and the capacitor Cin1 respectively rectify and filter an alternating current (AC) power to output a DC power VDC1. The DC power VDC1 serves as the working power for the control unit 140 and the driving unit 130. The control unit 140 controls the driving unit 130 to drive a load 20.

However, the conventional power conversion system 10 includes the following drawbacks. First, the control unit 140 and the driving unit 130 share the same DC power VDC1, so the power ripple ΔV1 of the DC power VDC1 can reach as high as 7V, thereby seriously influencing the stability of the circuit operation of the control unit 140. Second, the size of the power ripple ΔV1 changes with the variations of the frequency of the AC power AC, the capacitor Cin1 and the load 20. Thus, if the power ripple ΔV1 is to be kept unchanged with the change of the load 20, the capacitance of the capacitor Cin1 has to be increased so that the system cost is increased. Third, if the frequency of the AC powerAC is too low, the capacitance of the capacitor Cin1 also has to be increased so that the system cost is increased. Fourth, when the power ripple ΔV1 is too large, the circuit design may become difficult.

### SUMMARY OF THE INVENTION

The invention is directed to a power conversion system and a power conversion method thereof, wherein electric powers are respectively and independently supplied to a driving unit and a control unit. Thus, the following advantages can be obtained.

First, because the driving unit and the control unit are respectively and independently powered, the control unit has the better stability.

Second, the driving unit and the control unit are respectively and independently powered and the power consumption of the control unit is small. So, a capacitor with the lower capacitance can be selected to filter the DC power inputted to the control unit so that the system cost can be reduced.

Third, the power ripple of the DC power inputted to the control unit is greatly reduced. So, the difficulty of the circuit design can be reduced.

According to a first aspect of the present invention, a power conversion system is provided. The power conversion system includes a driving unit, a control unit, a first DC power supply circuit and a second DC power supply circuit. The control unit controls the driving unit to drive a load. The first DC power supply circuit converts an AC power into a first DC power outputted to the driving unit, while the second DC power supply circuit converts the AC power into a second DC power outputted to the control unit.

According to a second aspect of the present invention, a power conversion method is provided. The power conversion method includes the steps of: converting an AC power into a first DC power outputted to a driving unit; and converting the AC power into a second DC power outputted to a control unit to control the driving unit to drive a load.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing a conventional power conversion system for driving a load.

FIG. 2 (Prior Art) shows a waveform of a DC power.

FIG. 3 is a schematic illustration showing a power conversion system for driving a load according to a preferred embodiment of the invention.

FIG. 4 shows a waveform of a DC power.

FIG. 5 is a detailed schematic illustration showing the power conversion system for driving the load.

FIG. 6 is a detailed circuit diagram showing the power conversion system for driving the load.

FIG. 7 is a flow chart showing a power conversion method according to the preferred embodiment of the invention.

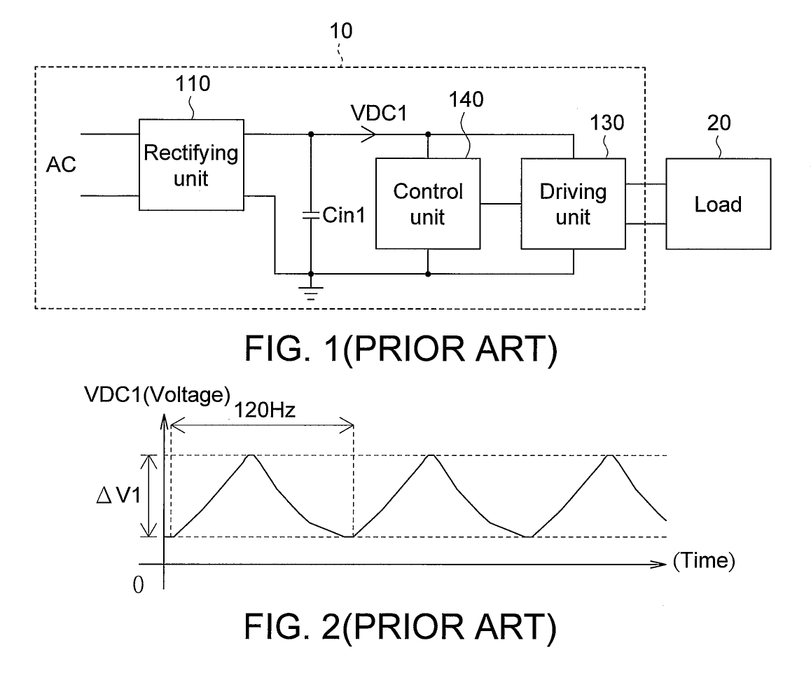

### DETAILED DESCRIPTION OF THE INVENTION

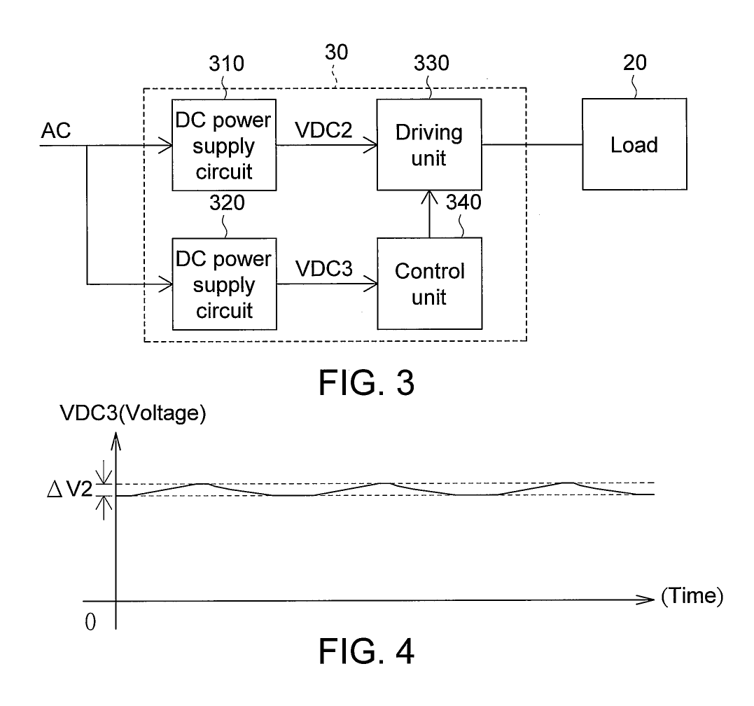

FIG. 3 is a schematic illustration showing a power conversion system 30 for driving a load according to a preferred embodiment of the invention. FIG. 4 shows a waveform of a DC power. Referring to FIGS. 3 and 4, the power conversion system 30 includes a driving unit 330, a DC power supply circuit 310, a control unit 340 and a DC power supply circuit 320. The control unit 340 controls the driving unit 330 to drive a load 20. The DC power supply circuit 310 converts an AC power AC into a DC power VDC2 outputted to the driving unit 330. The DC power supply circuit 320 converts the AC power AC into a DC power VDC3 outputted to the control unit 340.

The DC power supply circuit 310 and the DC power supply circuit 320 respectively and independently supply the powers to the driving unit 330 and the control unit 340. So, the stability of the control unit 340 cannot be influenced even if the DC power VDC2 has the very large power ripple and noise. In addition, as shown in FIG. 4, the power ripple ΔV2 of the DC power VDC3 is far smaller than the power ripple generated by the conventional power conversion system. Thus, the control unit 340 can stably control the driving unit 330.

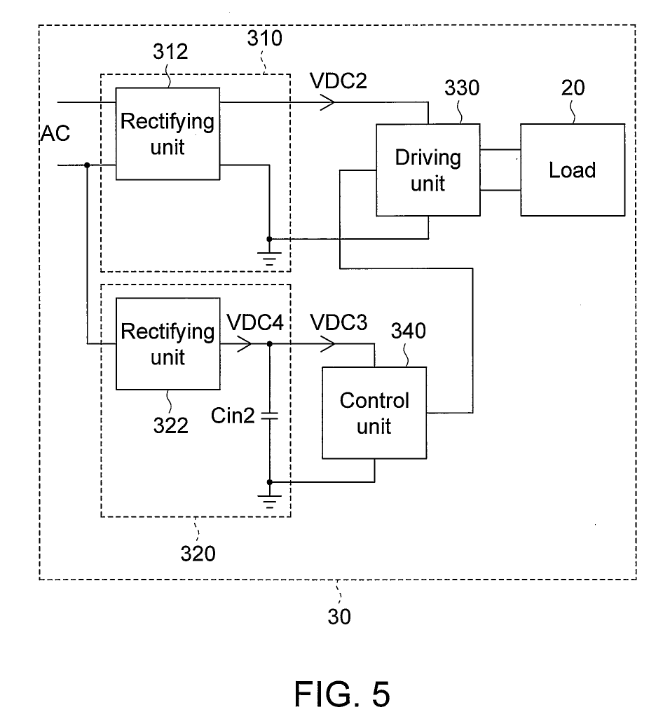

FIG. 5 is a detailed schematic illustration showing the power conversion system for driving the load. Referring to FIG. 5, the DC power supply circuit 310 includes a rectifying unit 312 for rectifying the AC powerAC into the DC power VDC2 outputted to the driving unit 330. The DC power supply circuit 320 includes a rectifying unit 322 and a capacitor Cin2. The rectifying unit 322 rectifies the AC power AC into a DC power VDC4 outputted to the capacitor Cin2, and the capacitor Cin2 filters the DC power VDC4 and then outputs the DC power VDC3 to the control unit 340.

The DC power supply circuit 310 and the DC power supply circuit 320 respectively and independently supply the powers to the driving unit 330 and the control unit 340, and the control unit 340 has the low power consumption. So, the selected capacitor Cin2 may have the smaller capacitance to decrease the system cost.

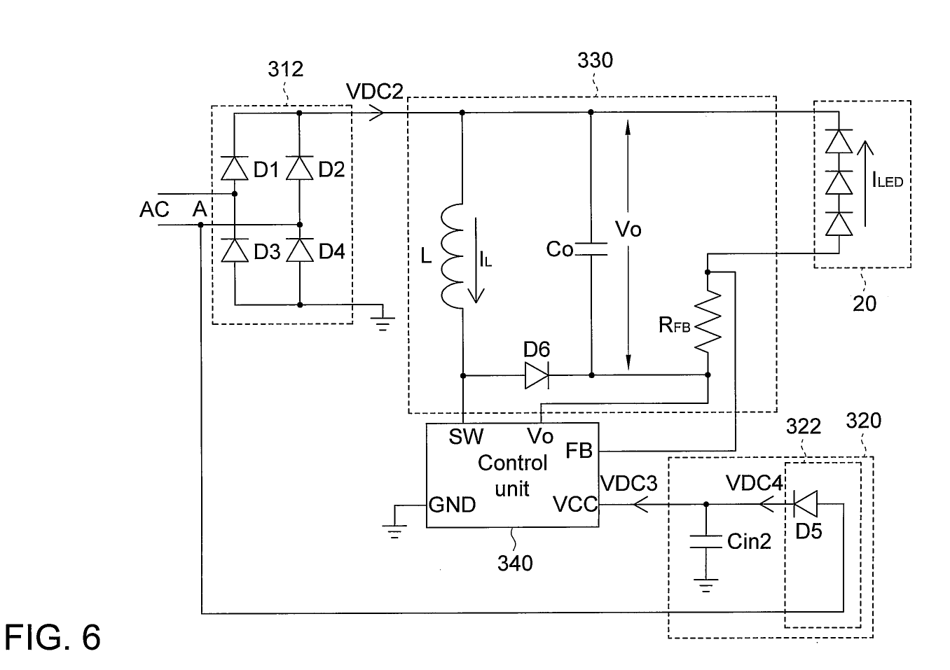

The control unit 340 is, for example, a buck-boost converter, a buck converter or a boost converter. The driving unit 330 may be, for example, a pulse width modulation (PWM) controller or a pulse frequency modulation (PFM) controller. In order to make the invention be easily understood, the driving unit 330 and the control unit 340 of FIG. 6 are respectively the buck-boost converter and the PFM controller in the illustrated example.

FIG. 6 is a detailed circuit diagram showing the power conversion system for driving the load. As shown in FIG. 6, the load 20 is a light-emitting diode (LED), for example. The rectifying unit 312 including a bridge rectifier composed of diodes D1 to D4 rectifies the AC power AC into the DC power VDC2 outputted to the driving unit 330. The rectifying unit 322 includes a diode D5 for rectifying the AC power AC into the DC power VDC4 outputted to the capacitor Cin2. The capacitor Cin2 filters the DC power VDC4 to output the DC power VDC3 to the control unit 340.

The driving unit 330 and the control unit 340 are respectively a buck-boost converter and a PFM controller, for example. The PFM controller includes a switch terminal SW, a ground GND, a power supply source VCC, a feedback terminal FB and an output terminal Vo. The ground GND is coupled to the ground, and the power supply source VCC receives the DC power VDC3 outputted from the DC power supply circuit 320.

In detail, the driving unit 330 includes an inductor L, a diode D6, a capacitor Co and a resistor RFB. A first terminal of the inductor L is coupled to first terminals of the rectifying unit 312 and the capacitor Co, and a second terminal of the inductor L is coupled to a positive terminal of the diode D6 and the switch terminal SW of the control unit 340. A second terminal of the capacitor Co is coupled to a negative terminal of the diode D6, the output terminal Vo of the control unit 340 and a first terminal of the resistor RFB. A second terminal of the resistor RFB is coupled to the feedback terminal FB of the control unit 340 in order to adjust the output voltage Vo according to a level of a feedback signal of the resistor RFB. When the driving unit 330 is the buck-boost converter, the output voltage Vo may be lower than, higher than or equal to the DC power VDC2. The control unit 340 controls the driving unit 330 to output the output voltage Vo according to a duty cycle D of a PWM signal, wherein the output voltage is equal to:

$$Vo = \frac{D}{1 - D} \times VDC 2.$$

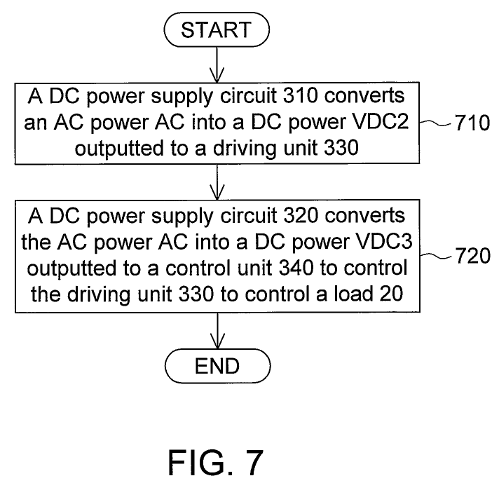

FIG. 7 is a flow chart showing a power conversion method according to the preferred embodiment of the invention. Referring to FIG. 7, the power conversion method may be applied to the power conversion system 10, and the power conversion method includes the following steps. First, as shown in step 710, the DC power supply circuit 310 converts the AC power AC into the DC power VDC2 outputted to the driving unit 330. Next, as shown in step 720, the DC power supply circuit 320 converts the AC power AC into the DC power VDC3 outputted to the control unit 340 to control the driving unit 330 to drive the load 20.

In the power conversion system and the power conversion method thereof, the electric powers are respectively and independently supplied to a driving unit and a control unit. Thus, the following advantages can be obtained.

First, because the driving unit and the control unit are respectively and independently powered, the control unit has the better stability.

Second, the driving unit and the control unit are respectively and independently powered and the power consumption of the control unit is small. So, a capacitor with the lower capacitance can be selected to filter the DC power inputted to the control unit so that the system cost can be reduced.

Third, the power ripple of the DC power inputted to the control unit is greatly reduced. So, the difficulty of the circuit design can be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power conversion system, comprising:
a driving unit;
a first direct current (DC) power supply circuit for converting an alternating current (AC) power into a first DC power outputted to the driving unit;
a control unit for controlling the driving unit to drive a load; and
a second DC power supply circuit for converting the AC power into a second DC power outputted to the control unit.

2. The power conversion system according to claim 1, wherein the second DC power supply circuit comprises:
a rectifying unit for rectifying the AC power into a third DC power; and
a capacitor for filtering the third DC power and thus outputting the second DC power.

3. The power conversion system according to claim 2, wherein the rectifying unit is a diode.

4. The power conversion system according to claim 1, wherein the first DC power supply circuit comprises:
a rectifying unit for rectifying the AC power into the first DC power.

5. The power conversion system according to claim 4, wherein the rectifying unit is a bridge rectifier.

6. The power conversion system according to claim 1, wherein the driving unit is a buck-boost converter.

7. The power conversion system according to claim 1, wherein the driving unit is a buck converter.

8. The power conversion system according to claim 1, wherein the driving unit is a boost converter.

9. The power conversion system according to claim 1, wherein the control unit is a pulse width modulation (PWM) controller.

10. The power conversion system according to claim 1, wherein the control unit is a pulse frequency modulation (PFM) controller.

11. A power conversion method, comprising:
(a) converting an alternating current (AC) power into a first direct current (DC) power outputted to a driving unit; and
(b) converting the AC power into a second DC power outputted to a control unit to control the driving unit to drive a load.

12. The method according to claim 11, wherein the step (b) comprises:
(b1) rectifying the AC power into a third DC power; and
(b2) filtering the third DC power to output the second DC power to the control unit.

13. The method according to claim 11, wherein the step (a) converts the AC power into the first DC power outputted to a buck-boost converter.

14. The method according to claim 11, wherein the step (a) converts the AC power into the first DC power outputted to a buck converter.

15. The method according to claim 11, wherein the step (a) converts the AC power into the first DC power outputted to a boost converter.

16. The method according to claim 11, wherein the step (a) converts the AC power into the second DC power outputted to a pulse width modulation (PWM) controller.

17. The method according to claim 11, wherein the step (a) converts the AC power into the second DC power outputted to a pulse frequency modulation (PFM) controller.

18. The method according to claim 11, wherein the step (a) outputs the AC power to a rectifying unit to convert the AC power into the first DC power.

19. The method according to claim 11, wherein the step (b) outputs the AC power to a rectifying unit and a capacitor to convert the AC power into the second DC power.
